(19) United States
(12) Patent Application Publication
(10) Pub. No.: US 2007/0293156 A1
(43) Pub. Date: Dec. 20, 2007

(54) Managing congestion in an electrical power transmission network

(75) Inventors: Cherry Yuen, Baden (CH); Mats Larsson, Baden (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 11/889,943

(22) Filed: Aug. 17, 2007

Related U.S. Application Data
(63) Continuation of application No. PCT/CH05/00125, filed on Mar. 3, 2005.

(51) Int. Cl. H04B 15/00

(52) U.S. Cl. 455/63.3

(57) ABSTRACT

A method and system are disclosed for managing congestion in an electrical transmission network. The electrical transmission network includes Power Flow Control Devices (PFDs) that adjust the transmission capability of the electrical transmission network. The method includes determination of a reference generation schedule followed by setting up of an objective function based on the reference generation schedule, a power flow in the electrical transmission network, bids for regulation, an actual generation schedule, and set points of PFDs. An optimisation problem is solved to minimize the objective function for a set of decision variables and the set of decision variables is applied in order to minimize congestion cost in the electrical transmission network.

### RELATED APPLICATIONS

This application claims priority as a continuation application under 35 U.S.C. §120 to PCT/CH2005/000125 filed as an International Application on Mar. 3, 2005, designating the U.S., the entire contents of which are hereby incorporated by reference in their entireties.

### TECHNICAL FIELD

The disclosure relates to managing power flow in electrical power transmission networks, and, more particularly, congestion management in electrical transmission networks comprising parallel transmission paths for carrying power from a power generating unit to a load as well as a Power Flow Control Device for adjusting a distribution of power flow on the transmission paths.

### BACKGROUND INFORMATION

Consumption of electrical energy has increased manifolds over the past few decades. Electrical energy finds its use in communications, entertainment, businesses, etc. that are heavily dependent upon electrical energy for operations. In order to transfer electrical energy from the source of generation to the source of consumption, power distribution systems or grids are utilized. Also known as electrical transmission networks, these grids provide electrical energy to households, businesses, manufacturing facilities, etc.

Since a huge amount of electrical energy is transmitted, managing the power flow that takes place through the electrical transmission network can be difficult. In typical electrical transmission networks, power flow is divided over multiple paths according to the least impedance principle to any given load where it is consumed. Such electrical transmission networks are highly dynamic and operations are often concerned with balancing generation with load. In response to a change in network state, loads or power injected by generating units, power flow over alternate transmissions paths may need to be redistributed in order to avoid violations of operational constraints on individual network components. These adjustments are made according to the topology of, as well as the current electrical flow situation in, the electrical transmission network.

The challenges of power flow management in electrical transmission networks have significantly increased due to integration of power systems across several regions. Changes in price levels and/or demand for power at different points in the electrical transmission network may result in congestion. The consequences of congestion include price spikes, load dropping, and if these measures do not suffice, loss of power distribution to one or more regions.

An approach to power flow management employs a Day-Ahead Market (DAM) for energy methodology. An exemplary DAM for Energy includes demand bidding and virtual supply and demand bids and offers. By noon on the day before the operating day, market participants submit market information to an Independent System Operator (ISO). The market information submitted to the ISO includes information about generating units, Load Serving Entities (LSE), and participants. The generating units essentially offer to supply energy and regulation service to the market and operating characteristics of generating units for consideration in the clearing of the DAM. The LSE bid to buy energy in the DAM and the participants make virtual supply offers and demand bids.

The ISO clears the DAM on the day before the operating day and publishes the cleared quantities and prices. The DAM bid and offered quantities and prices that clear, are financially binding upon the participants who submitted them. As there exists a different price structure in regions that are competing, bottlenecks are observed in the potential energy transmission between them. This leads to congestion when the ISO tries to equilibrate the prices by transmitting more power than allowed.

There is also a provision for up-regulation and down-regulation bids in a second or further market. These bids denote the quantity of energy and the price the generating units are willing to add or subtract in order to deviate from what was agreed upon in the previous round ignoring congestion, resulting in more or less power generated.

However, such energy market clearing mechanisms do not take into account the possibility of redistributing power flow on electrically parallel transmission paths, by using so-called Power Flow Control Devices (PFD) to maximize the total transfer capability while respecting operational constraints on individual network components.

### SUMMARY

It is therefore an objective of the disclosure to provide a flexible and effective way of managing congestion in an electrical power transmission network comprising Power Flow Control Devices (PFD) for controlling power flow. This objective can be achieved by a method of, a system for and a computer program for managing congestion in an electrical power transmission network comprising electrically parallel transmission paths between a power generating unit and a power load as well as a Power Flow Control Device (PFD) for adjusting a distribution of power flow on the transmission paths.

According to the disclosure, congestion management of an electrical power transmission network is performed by taking advantage of the flexibility in creating the total transmission capability resulting from the use of PFDs. In addition to an actual generation schedule of the power generating units, also the set points of the PFDs are employed as additional decision variables in an optimisation problem, resulting in a broader range of possible power flow solutions consistent with the respective transmission capabilities of the network than without PFDs. Consequently, the congestion cost in the transmission network, i.e. the difference between the amount of money to be received and/or paid when a) ignoring and b) respecting congestion constraints, may be further optimised.

The disclosure includes determination of a reference generation schedule of at least one power generating unit followed by setting up of an optimisation problem comprising a set of constraints or boundary conditions and an objective function representing the congestion cost. The optimisation problem involves the reference generation schedule, a power flow in the electrical transmission network, regulating bids from market participants, as well as the actual generation schedule and the set points of the PFDs. The method then solves the optimisation problem to minimize the objective function for a set of decision variables and applies this set of decision variables to minimize congestion costs in the electrical transmission network.

In exemplary embodiments of the disclosure, the reference generation schedule is determined based on supply and demand bids from the market participants, i.e. the power generating units and the power consumers or loads. Only regulating bids from the power generating units however are considered in the optimisation problem, such that the loads are unaffected by the optimisation that is entirely negotiated between an Independent System Operator and the power generating units. In other words, the amount of demand does not vary with the resulting market settlement price and congestion cost, which considerably simplifies the procedure.

In another exemplary variant of the disclosure, the PFD is a series capacitor, a Phase-Angle Reactor (PAR), a series reactor, or a Flexible Alternating Current Transmission System (FACTS) device. The latter include Static-Var Compensator (SVC), Thyristor-Controlled Series Capacitors (TSCSs), phase-shifting transformers, impedance modulators, series compensation capacitors, and the like. These devices are installed at transmission line stations to adjust power flow in each transmission line, so that power can be guided to flow in a safe, stable and balanced manner in a large number of lines within the electrical transmission network.

### BRIEF DESCRIPTION OF THE DRAWINGS

The subject matter of the invention will be explained in more detail in the following text with reference to the exemplary embodiments illustrated in the attached drawings, of which:

FIG. 1 depicts a model of a two-area power system,

FIG. 2 is a flowchart depicting a method of managing congestion in an electrical transmission network, according to an exemplary embodiment;

FIG. 3 schematically depicts the basic elements of a system for managing congestion in an electrical transmission network, according to an exemplary embodiment; and

FIG. 4 schematically depicts the basic approach for managing congestion in an electrical transmission network, according to an exemplary embodiment.

The reference symbols used in the drawings, and their meanings, are listed in summary form in the list of reference symbols. In principle, identical parts are provided with the same reference symbols in the figures.

### DETAILED DESCRIPTION

The detailed description in connection with the appended drawings is intended as a description of the present exemplary embodiments, and is not intended to represent the only form in which the present disclosure may be practiced. It is to be understood that the same or equivalent functions may be accomplished by different embodiments that are intended to be encompassed within the spirit and scope of the invention.

The present disclosure provides a method and system for managing congestion in an electrical power transmission network. The electrical transmission network includes at least one power generating unit and at least one Power Flow Control Device (PFD). The method includes determination of a reference generation schedule of the power generating units followed by setting up of an optimisation problem including an objective function and a set of constraints, and based on the reference generation schedule, a power flow in the electrical transmission network, bids for regulation, an actual generation schedule, and set points of PFDs. An optimisation problem is solved to minimize the objective function for a set of decision variables and the set of decision variables is applied in order to minimize congestion in the electrical transmission network.

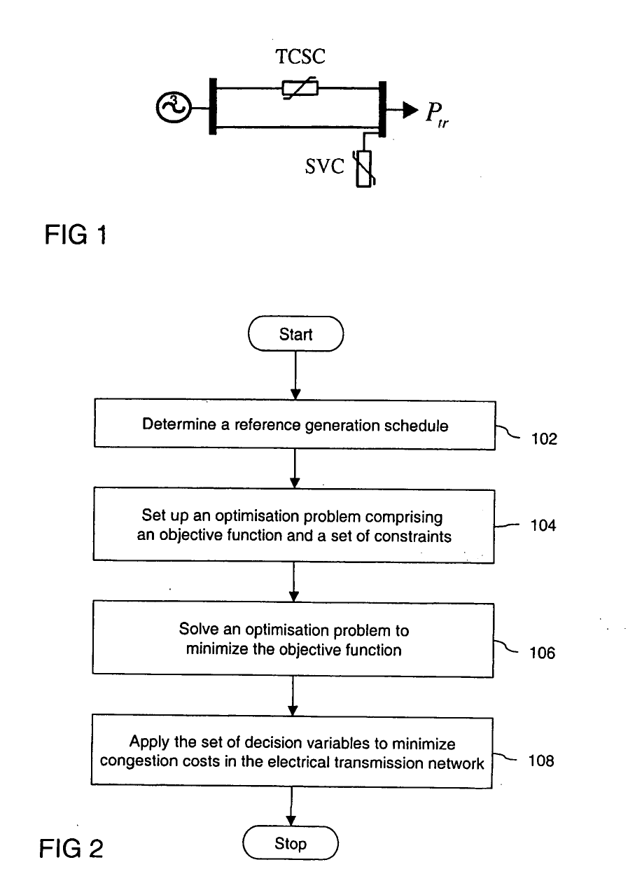

For illustrative purposes, a model of a simple two-area power system is depicted in FIG. 1. The generation unit is modeled as an ideal or stiff voltage source and each of the two lines as pure reactances. Furthermore, one of the lines has a PFD installed. The line with the PFD is modeled as a varying apparent reactance jX₁ depending on its set point uₛₚ, whereas the other line has a fixed reactance jX₂. The load bus to the right has a Static Var Compensator SVC. The SVC and its associated set point controller is modeled as a variable admittance jB_{svc}. A load current is drawn through a purely resistive load admittance pG₁ where p is simply a scale factor of the load used to investigate the maximum loadability. An analysis of this system shows that the maximum loadability is increased either by increasing the compensation by the PFD, that is, by a reduction of the apparent line reactance X₁, or by increasing the compensation by the SVC, that is, by an increase of the susceptance B_{svc}

Referring now to FIG. 2, a flowchart depicts a method of managing congestion in an electrical transmission network, according to an exemplary embodiment of the present disclosure. The electrical transmission network includes power generating units and PFDs. The PFDs are used to adjust properties of the electrical transmission network to change a distribution of power flow on electrically parallel transmission paths. Exemplary PFDs include series capacitors, Phase-Angle Reactors (PARs), series reactors, and Flexible Alternating Current Transmission Systems (FACTS) devices. FACTS devices include Static-Var Compensators (SVCs) and Thyristor-Controlled Series Capacitors (TSCSs), phase-shifting transformers, impedance modulators, and series compensation capacitors.

These devices are installed at transmission line stations to adjust power flow in each transmission line, so that power can be guided to flow in a safe, stable and balanced manner in a large number of lines within the electrical transmission network. FACTS devices improve dynamic performance of electrical transmission networks. They are designed to provide stability enhancements, thereby allowing transmission facilities to be loaded to levels approaching their ultimate thermal capacity. These devices may supply reactive power to support voltage or provide modulation to damp electromechanical oscillations.

At step 102, a reference generation schedule is determined. A set of power generating units that generate electrical energy for the electrical transmission network takes this reference generation schedule to generate electrical energy. At step 104, an optimisation problem comprising an objective function and a set of constraints is set up. The optimisation problem involves the reference generation schedule, a power flow in the electrical transmission network, bids for regulation, an actual generation schedule, and at least one set point of the PFDs. The actual generation schedule and the set points of the PFDs are decision variables, whereas the reference generation schedule and the bids for regulation are fixed parameters, of an objective function. The objective function essentially represents a congestion cost in the electrical transmission network and is used to determine a cost to be paid by an Independent System Operator (ISO) to the generating units for deviating from a reference schedule agreed upon earlier.

At step 106, an optimisation problem is solved to minimize the objective function for a set of decision variables. Subsequently, at step 108, the set of decision variables is applied in the electrical transmission network to minimize congestion costs.

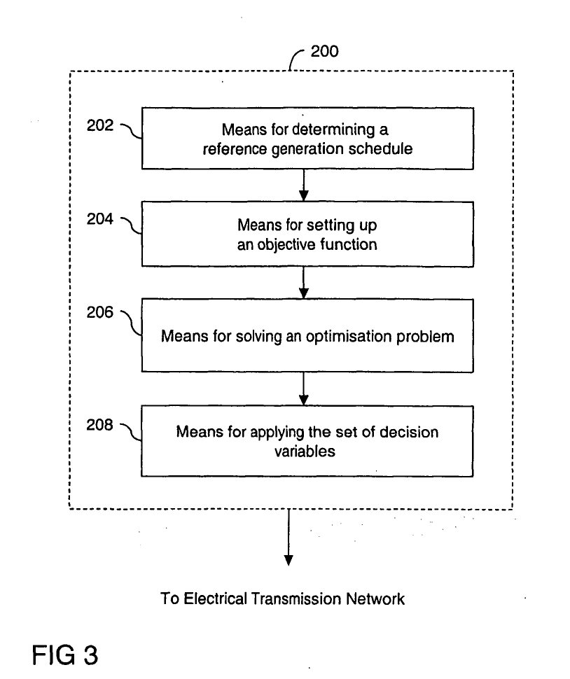

FIG. 3 schematically depicts the basic elements of a system for managing congestion in an electrical transmission network, according to an exemplary embodiment of the present disclosure. System for managing congestion 200 includes a means for determining a reference generation schedule 202 for power generating units, a means for setting up an objective function 204, a means for solving an optimisation problem 206, and a means for applying the set of decision variables 208. The elements of the system for managing congestion 200 do perform the steps as described above and are preferably implemented in the form of software modules.

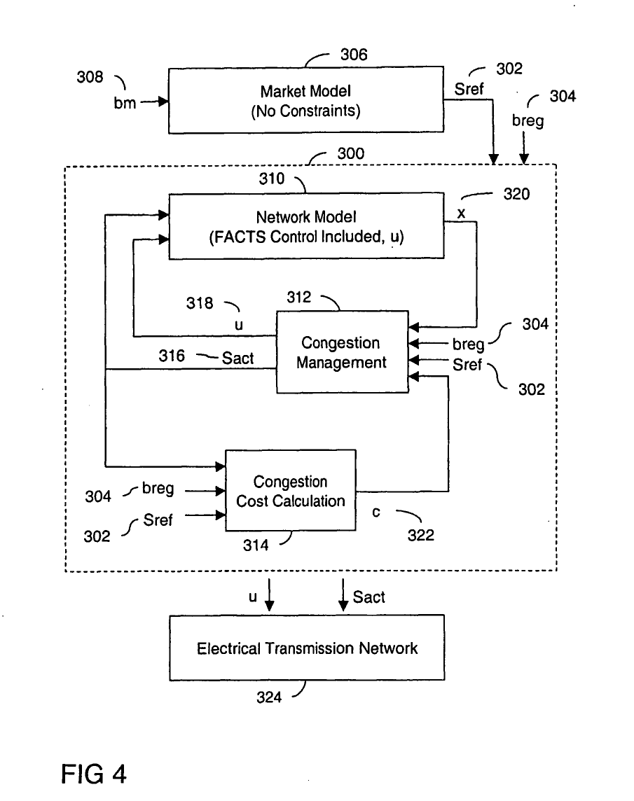

FIG. 4 schematically depicts the basic approach for managing congestion in an electrical transmission network, according to an exemplary embodiment of the present disclosure. It is assumed that generation re-dispatch alone is enough to handle the congestion constraints and so load shedding is not required. For the purpose of illustration, the arrows in FIG. 4 describe a hypothetical iterative process, however an exemplary way of obtaining a self-consistent and optimised solution makes use of commercial solvers as discussed further below.

In FIG. 4, a model for managing congestion 300 includes the computational blocks employed by the mechanism of the present disclosure. Model for managing congestion 300 takes as input a reference generation schedule S_{ref} 302 and regulating bids for up-regulation and down-regulation b_{reg} 304. The reference generation schedule S_{ref} 302 is generated by a market model 306 assuming no constraints. Market model 306 takes as input a number of market participant bids bₘ 308. This way of modelling S_{ref} 302 is consistent with most energy market settlement mechanism, in which a system price is first found by using all the bids submitted by market participants without considering any binding transmission constraints. In an exemplary embodiment, S_{ref} 302 is provided by the means for generating a reference schedule 202.

An exemplary model for managing congestion 300 includes a network model 310, a congestion management block 312, and a congestion cost calculation block 314. The congestion management block 312 takes as input the reference generation schedule S_{ref} 302 and the regulating bids b_{reg} 304, as well as a congestion cost c_{con} and a power flow x_{pf}. Cost c_{con} and flow x_{pf} both belong to a particular power flow distribution consistent with the respective transmission capabilities of the network and defined by an actual generation schedule S_{act} 316 in conjunction with actual set points uₛₚ 318 of the PFDs. Both the actual generation schedule S_{act} 316 and the actual set points uₛₚ 318 are suggested by congestion management block 312, and taken as input by the network model 310 generating the power flow solution x_{pf} 320. Congestion cost calculation block 314 takes as inputs the actual generation schedule S_{act} 316, the regulating bids b_{reg} 304, and the reference generation schedule S_{ref} 302 and generates the congestion cost c_{con} 322. The optimized ultimate values of the actual generation schedule S_{act} 316 and the actual set points uₛₚ 318 are finally applied on an electrical power transmission network 324 to minimize congestion costs.

In the case of no demand elasticity, the congestion cost is the difference of the generation costs taking and not taking congestion constraints into account and is therefore formulated as a function of the actual generation schedule S_{act} 316 with congestion and the reference generation schedule S_{ref} 302 before taking congestion into account. The constraints or inequalities of the optimisation problem constrain both the set points uₛₚ 318 and the actual generation schedule S_{act} 316 not only via the power flow solution x_{pf} 320, but also in a more direct way in the form of physical or operational limits to the settings and schedules. The optimisation problem is in a general way formulated as follows:
min C(X,S_{act}, S_{ref}, u) (1)
subject to: g(x, S_{act}, u)=0 and h(x, S_{act}, u)≦0.

wherein g(.) represents the equality constraint(s) while h(.) represents the inequality constraint(s). A typical set for g(.) and h(.) would be:

$$\begin{matrix}{\sum }_{i} {p}_{i} = D , i ∈ G & Power Balance \\ {C}_{i}^{min} \leq {\sum }_{i} {p}_{i} \leq {C}_{i}^{max} , i ∈ G & Capacity Constraints \\ {f}_{k}^{min} \leq {f}_{k} \leq {f}_{k}^{max} , k ∈ T & Line Thermal Constraints\end{matrix}$$

wherein D is total system load (and losses), G is the set of generating units, T is the transmission line set, pᵢ is the generation from the i^{th} generating unit and as such part of the actual generation schedule S_{act}, C^{min}ᵢ is the minimum capacity of the i^{th} generating unit, C^{max}ᵢ is the maximum capacity of the i^{th} generating unit, fₖ is the power flow on the k^{th} transmission line and as such part of the power flow solution x_{pf}, f^{min}ₖ is the lower bound for the power flow on the k^{th} transmission line, and f^{max}ₖ is the upper bound for the power flow on the k^{th} transmission line. The transmission constraints are the constraints imposed on the transfer capacity of a single or a group of transmission lines because of a thermal limit, voltage or other security constraints (e.g. n-1 contingencies). They are usually expressed in units of MW. Likewise, corresponding constraints apply to the values of the set points uₛₚ of the PFDs.

Self-consistent solutions to the problem as set out above can be obtained by reverting to the commercial optimisation problem solver called “CPLEX” for solving linear, mixed-integer and quadratic programming problems (http://www.ilog.com/products/cplex/). In an exemplary embodiment, model for managing congestion 300 is embodied in means for setting up an objective function 204 and means for solving an optimisation problem 206.

Transmission constraints may result in financial impact on different parties in energy markets. In general, these parties can be categorised into three groups: ISO, generating units and loads. Depending on the congestion cost calculation protocol, the parties can have a gain or a loss upon congestion. The exemplary methodology as described can be formulated to minimize the total congestion cost for all or any individual one of the parties.

In order to describe the mechanism employed by the present disclosure, an example of congestion cost minimisation for ISO is given below in the description. The congestion pricing protocol is based on the counter-trading mechanism, which should be apparent to one skilled in the art. With this approach, there are no financial effects on the consumers, i.e., loads, in case of congestion, but there will be compensation paid by the ISO to the generating units to deviate from the original reference schedule S_{ref} 302. As mentioned previously, in the case of no demand elasticity, the congestion cost is formulated as a function dependent on the generation dispatch, i.e. the difference of the actual schedule S_{act} 316 and the reference schedule S_{ref} 302 of the generating units. The costs that the ISO has to pay are the summation of two parts—costs for up-regulation and costs for down-regulation.

For down regulation:

$${C}_{down} = {\sum }_{i} ( ( {Sref}_{i} - {Sact}_{i} ) * ( {c}_{ref} - {c}_{down} ) ) \qquad ( 2 )$$

wherein c_{ref} is the system clearing price, previously fixed on the basis of the demand and supply bids bₘ 308 of the loads and the generating units, respectively, c_{down} is the price for down regulation, based on generating unit's regulating bids b_{reg} 304, and i is the index for down-regulating generating units.

Similarly for up-regulation:

$${C}_{up} = {\sum }_{j} ( ( {Sact}_{j} - {Sref}_{j} ) * ( {c}_{up} - {c}_{ref} ) ) \qquad ( 3 )$$

wherein, c_{ref} is the system clearing price, previously fixed on the basis of the demand and supply bids bₘ 308 of the loads and the generating units, respectively, cᵤₚ is the price for up regulation based on generating unit's regulating bids (b_{reg} 304), and j is the index for up-regulating generating units.

The total cost imposed on the ISO is therefore:
Cₜₒₜₐₗ=C_{down}+Cᵤₚ (4)

In this case the cost function in equation (1) is therefore formulated as:
C(x,S_{act},S_{ref},U)=Cₜₒₜₐₗ (5)

The congestion cost computed by equation 5 may then be utilized for deciding the cost to be paid by the ISO to the generating units.

The system, as described or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present disclosure.

The computer system comprises a computer, an input device, and a display unit and may have access to the Internet. Computer comprises a microprocessor. Microprocessor is connected to a communication bus. Computer also includes a memory. Memory may include Random Access Memory (RAM) and Read Only Memory (ROM). Computer system further comprises storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the exemplary method of the present disclosure. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. In particular the modules of the semi-automatic converter may be coded a high level language such as, for example, C, C++, C#, and Java. The processing of input data by the processing machine may be in response to user commands, or in response to results of previous processing or in response to a request made by another processing machine.

While the exemplary embodiments of the present disclosure have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

### LIST OF DESIGNATIONS

102 Step of determining a reference generation schedule
104 Step of setting up an objective function
106 Step of solving an optimisation problem to minimize the objective function
108 Step of applying the set of decision variables to minimize congestion costs in the electrical transmission network
200 System for managing congestion
202 Means for determining a reference generation schedule
204 Means for setting up an objective function
206 Means for solving an optimisation problem
208 Means for applying the set of decision variables
300 Model for managing congestion
302 Reference generation schedule represented by S_{ref}
304 Up-regulation and down regulation bids represented by b_{reg}
306 Market model
308 Market participant bids represented by bₘ
310 Network model
312 Congestion management block
314 Congestion cost calculation block
316 Actual generation schedule represented by S_{act}
318 Set point of FACTS device represented by u
320 Power flow solution represented by x
322 Output of congestion cost calculation block represented by c
324 Electrical Power Transmission Network

What is claimed is:

1. A method of managing congestion in an electrical power transmission network comprising electrically parallel transmission paths between a power generating unit and a load as well as a Power Flow Control Device (PFD) for adjusting a distribution of power flow on the transmission paths, the method comprising:
determining a reference generation schedule of the power generating unit;
setting up an optimisation problem comprising an objective function and a set of constraints, and being based on the reference generation schedule, a regulating bid, an actual generation schedule of the power generating unit, a power flow in the transmission network, and a set point of the PFD, wherein the objective function represents congestion cost in the transmission network, and wherein the actual generation schedule and the set point of the PFD are decision variables,
solving the optimisation problem to minimize the objective function for a set of decision variables respecting the set of constraints; and
applying the set of decision variables to minimize congestion costs in the electrical power transmission network.

2. The method according to claim 1, comprising
determining the reference generation schedule based on supply and demand bids from the power generating unit and the load.

3. The method according to claim 1, comprising
setting up the optimisation problem based exclusively on a bid for regulation from the power generating unit, and comprising an objective function representing a cost to be paid by an Independent System Operator to the power generating unit.

4. A system for managing congestion in an electrical power transmission network comprising electrically parallel transmission paths between a power generating unit and a load as well as a Power Flow Control Device (PFD) for adjusting a distribution of power flow on the transmission paths, the system comprising:
means for determining a reference generation schedule of the power generating unit;
means for setting up an optimisation problem comprising an objective function and a set of constraints, and being based on the reference generation schedule, a regulating bid, an actual generation schedule of the power generating unit, a power flow in the transmission network, and a set point of the PFD, wherein the objective function represents congestion cost in the electrical transmission network, and wherein the actual generation schedule and the set point of the PFD are decision variables;
means for solving the optimisation problem to minimize the objective function for a set of decision variables respecting the set of constraints; and
means for applying the set of decision variables to minimize congestion costs in the electrical power transmission network.

5. The system according to claim 5, wherein the PFD comprises at least one of an at least one series capacitor, at least one Phase-Angle Reactor, at least one series reactor, and at least one Flexible Alternating Current Transmission Systems device.

6. The system according to claim 5, comprising means for determining a reference generation schedule of a plurality of power generating units; and means for setting up an optimisation problem based on the reference generation schedule and an actual generation schedule of the plurality of power generating units.

7. A computer program for managing congestion in an electrical power transmission network comprising electrically parallel transmission paths between a power generating unit and a load as well as a Power Flow Control Device (PFD) for adjusting a distribution of power flow on the transmission paths, the computer program comprising computer program code means to make, when the computer program is loaded in an internal memory of a digital computer, said computer minimize an objective function for a set of decision variables respecting a set of constraints, wherein the objective function and the set of constraints are part of an optimisation problem being based on a reference generation schedule of a power generating unit, a regulating bid, an actual generation schedule of the power generating unit, a power flow in the transmission network, and a set point of the PFD, and wherein the objective function represents congestion cost in the transmission network, and wherein the actual generation schedule and the set point of the PFD are the decision variables.
